(19) United States
(12) Patent Application Publication
(10) Pub. No.: US 2011/0283849 A1
(43) Pub. Date: Nov. 24, 2011

(54) CUTTING PLOTTER AND CUTTING METHOD THEREOF

(75) Inventor: Takemi Takizawa, Nagano (JP)

(73) Assignee: MIMAKI ENGINEERING CO., LTD., NAGANO (JP)

(21) Appl. No.: 13/147,802

(22) PCT Filed: Jan. 26, 2010
(86) PCT No.: PCT/JP2010/000412

§ 371 Date: Aug. 3, 2011

(30) Foreign Application Priority Data
Feb. 13, 2009 (JP) 2009-032007

(51) Int. Cl. B26D 5/00

(52) U.S. Cl. 83/13; 83/368

(57) ABSTRACT

A cutting plotter (1) is provided with a guide rail (15a), a carriage (21) which is movable along the guide rail (15a), a cutter blade (26) which is mounted on the carriage (21), and a control unit which performs control for moving the carriage (21) and control for moving the cutter blade (26) in the upper and lower direction to perform a cutting work. When control for moving the carriage (21) along the guide rail (15a) is to be performed by the control unit, in a case that a distance between a sheet material (M) and the carriage (21) is wider than a predetermined distance, control for moving the cutter blade (26) in a direction biting into the sheet material (M) is added and, in a case narrower than the predetermined distance, control for moving the cutter blade (26) in a direction separated from the sheet material (M) is added.

### TECHNICAL FIELD

The present invention relates to a cutting plotter in which a cutting work is performed by means of relatively moving a cutting tool such as a cutter blade in a state where the cutting tool is pressed against a medium to be cut.

### BACKGROUND ART

The cutting plotters include a type in which, for example, a cutting work is performed by combining control for moving a sheet-shaped medium to be cut in a front and rear direction, control for moving a cutting tool in a right and left direction which is perpendicular to the front and rear direction, and control for pressing the cutter blade against the medium or separating from the medium. This type of cutting plotter is generally structured so that a cutting unit is movably mounted in a right and left direction with respect to a guide member (also referred to as a “Y”-bar) which is provided so as to extend in the right and left direction and the cutting tool is mounted on the cutting unit so as to be movable in an upper and lower direction.

FIG. 14 is a perspective view showing a guide member 800 in a conventional cutting plotter. The guide member 800 is structured of a guide main body part 810 which is extended in a right and left direction and a guide rail 820 which is mounted on a front face of the guide main body part 810 and extended in the right and left direction. The guide main body part 810 is formed by means of, for example, performing extrusion molding or drawing molding on aluminum material. The guide rail 820 is formed with groove parts 821 and 822 by machine working in a high degree of accuracy and a cutting unit (not shown) is mounted on the groove parts 821 and 822 so as to be movable in the right and left direction. A platen 830 on an upper face of which a medium to be cut is placed is located on a lower side of the guide member 800.

When a cutting work is to be performed by utilizing the structure as described above, a cutting plotter is required to be used which comprises the guide member 800 whose width in the right and left direction is wider than a medium to be used. Conventionally, most of cutting works are performed for a medium whose width in the right and left direction is relatively narrow (for example, width in the right and left direction is about 50 cm). In order to perform a cutting work on such a medium, the guide member 800 whose width in the right and left direction is about 60 cm is used to structure the cutting plotter. The guide main body part 810 is formed by extrusion molding or drawing molding and thus it is difficult that the guide main body part 810 is manufactured in a strictly straight shape and, for example, distortion of about 0.3 mm is occurred in the guide member 800 whose width in the right and left direction is about 60 cm.

Especially, when a cutting work is performed on a medium whose thickness is about 2-3 mm, a force (cutting pressure) with which a cutting tool is pressed on the medium is partially varied due to the above-mentioned distortion of about 0.3 mm and thus a biting depth of the cutting tool becomes non-uniform and its cutting quality may be affected.

Therefore, when the guide rail 820 is to be mounted on the guide main body part 810, fine adjustment is required so that a vertical distance between the guide rail 820 and the platen 830 is set to be constant. In this manner, the distortion of about 0.3 mm occurred in the guide main body part 810 is prevented from affecting the cutting quality. Various techniques relating to control of the cutting pressure have been conventionally proposed (see, for example, Patent Literatures 1 and 2).

### RELATED PRIOR ART LIST

### [Patent Literature]

[PTL 1] Japanese Patent Laid-Open No. 2003-220594

[PTL 2] Japanese Patent Laid-Open No. Hei 11-129197

### SUMMARY OF INVENTION

### Technical Problem To Be Solved

Recently, a cutting work is required to be performed on a medium whose width in the right and left direction is wide (for example, about 1.5 m). In order to perform a cutting work on such a medium, a cutting plotter is required to be structured so that the guide member 800 whose width is about 1.6 m is used. When the guide member 800 of about 1.6 m is formed by extrusion molding or drawing molding, distortion of at least about 1 mm may occur in the current forming technique. As described above, even when the guide rail 820 is mounted while being adjusted on the guide member 800 having distortion of about 1 mm, it is difficult to fully eliminate the effect of distortion of the guide member 800 which affects the cutting quality. Further, since the guide rail 820 is manufactured by a highly accurate machine working, a manufacturing cost is increased and, especially when the guide rail 820 whose length is about 1.6 m is manufactured, the manufacturing cost is remarkably increased.

In view of the problems described above, an objective of the present invention is to provide a cutting plotter which is capable of performing a cutting work on a medium whose width is wide with a high degree of quality while restraining its manufacturing cost, and provide its cutting method.

### Solution to Problem

In order to attain the above-mentioned objective, the present invention provides a cutting plotter including:
a medium support means (for example, the platen 12a in the embodiment) which supports a medium to be cut that is formed in a sheet shape (for example, a sheet material “M” in the embodiment);
a guide member (for example, the guide rail 15a in the embodiment) which is relatively moved in a feeding direction with respect to the medium supported on the medium support means in a state facing to the medium support means, and the guide member being provided so as to extend in a scanning direction perpendicular to the feeding direction;
a carriage which is attached to the guide member and is movable along the guide member in the scanning direction;
a cutting tool (for example, the cutter blade 26 in the embodiment) which is mounted on the carriage and is movable in a biting direction perpendicular to the medium that is supported on the medium support means; and
a working control means (for example, the control unit 50 in the embodiment) which performs control for relatively moving the guide member in the feeding direction, control for moving the carriage along the guide member, and control for moving the cutting tool in the biting direction to perform a cutting work on the medium by the cutting tool.
   When the control for moving the carriage in the scanning direction along the guide member is to be performed by the working control means, in a case that a distance between the medium and the carriage in the biting direction is wider than a predetermined distance, control for moving the cutting tool in the biting direction into the medium is added and, in a case that the distance between the medium and the carriage in the biting direction is narrower than the predetermined distance, control for moving the cutting tool is moved in a separating direction from the medium.

In the cutting plotter, it is preferable that the carriage is mounted with a solenoid (for example, the electromagnet 23 and the permanent magnet 28 in the embodiment) for moving the cutting tool in the biting direction, and the working control means performs control for moving the cutting tool in the biting direction by controlling a supply current to the solenoid.

In order to attain the above-mentioned objective, the present invention provides a cutting method performed in a cutting plotter. The cutting plotter includes a carriage which faces a medium support means supporting a medium to be cut that is formed in a sheet shape and which is movable along a guide member extended in a scanning direction, and a cutting tool which is mounted on the carriage so as to be movable in a biting direction perpendicular to the medium that is supported on the medium support means, and a cutting work is performed while the cutting tool is relatively moved with respect to the carriage in a state that the cutting tool is bitten into the medium. The cutting method includes a first step in which the cutting tool is moved in the biting direction depending on a distance between the medium and the carriage in the biting direction, and a second step in which the cutting tool having been moved in the first step is moved in the scanning direction along the guide member.

### Effects of Invention

A cutting plotter in accordance with the present invention is structured so that, in the control for moving the carriage in a scanning direction along the guide member, control is added in which the cutting tool is moved in the biting direction depending on a distance between the medium and the carriage in the biting direction. According to this structure, for example, even when the guide member having been occurred with distortion is used as it is, the cutting tool can be pressed against the medium with a desired cutting pressure (cutting depth). Therefore, the cutting depth of the cutting tool can be automatically prevented from being partially varied and a cutting work with a uniform cutting depth as a whole can be performed. Further, in the cutting plotter in accordance with the present invention, it is not required that the guide member and the guide rail are separately formed from each other and attached to each other while being adjusted to restrain the effect of distortion like the conventional case. For example, according to the present invention, a guide member integrally formed with a guide rail can be used. Therefore, an expensive guide rail is not required to be manufactured separately and thus the manufacturing cost can be reduced remarkably. In addition, since distortion of the guide member may be permitted to some extent, a high-quality cutting work can be performed on a medium whose width is about 1.5 m in the right and left direction by using a guide member occurred with distortion as it is, for example, whose length is about 1.6 m.

In the cutting plotter described above, a structure is preferable that a solenoid for moving the cutting tool in a biting direction is mounted on the carriage. According to this structure, for example, when a supply current to the solenoid is controlled, movement responsiveness of the cutting tool in the biting direction can be enhanced and a moving amount (moving position) of the cutting tool at this time can be controlled with a high degree of accuracy.

A cutting method in accordance with the present invention includes a first step in which a cutting tool is moved in a biting direction depending on a distance between a medium to be cut and a carriage in the biting direction and a second step in which the cutting tool is moved in a scanning direction along the guide member. According to this cutting method, for example, even when the guide member occurred with distortion is used as it is, the cutting tool can be pressed against a medium with a desired cutting pressure (cutting depth). Therefore, the cutting depth of the cutting tool can be automatically prevented from being partially varied and a cutting work with a uniform cutting depth as a whole can be performed.

### BRIEF DESCRIPTION OF DRAWINGS

FIG. 1 is a front view showing a cutting plotter to which the present invention is applied.

FIG. 2 is a perspective view showing a cutting unit and its periphery in the cutting plotter.

FIGS. 3(a) and 3(b) are cross-sectional views showing a “III-III” portion in FIG. 2. FIG. 3(a) shows a state where a support part has been moved to a lower side and FIG. 3(b) shows a state where the support part has been moved to an upper side.

FIG. 4 is a graph showing a relationship between a stroke of a cutter blade and a cutting pressure.

FIG. 5 is a systematic control diagram for the cutting plotter.

FIG. 6 is a schematic view showing a distorted state of a guide rail.

FIG. 7 is a table showing a relationship between a stroke information and an electric current value.

FIG. 8 is a graph showing a relationship between stroke informations and a cutting pressure.

FIG. 9 is a graph showing control at a biting time and a separated time.

FIG. 10(a) is a plan view showing a sheet material which is performed with a cutting work. FIG. 10(b) is a table showing a relationship (control table) between a stroke information and an electric current value in each of regions.

FIG. 11 is a flow chart when a cutting work is performed.

FIG. 12 is a front view showing a cutting plotter in accordance with a second embodiment.

FIG. 13 is a block diagram showing a cutting plotter in accordance with a third embodiment.

FIG. 14 is a perspective view showing a guide rail which is mounted on a conventional cutting plotter.

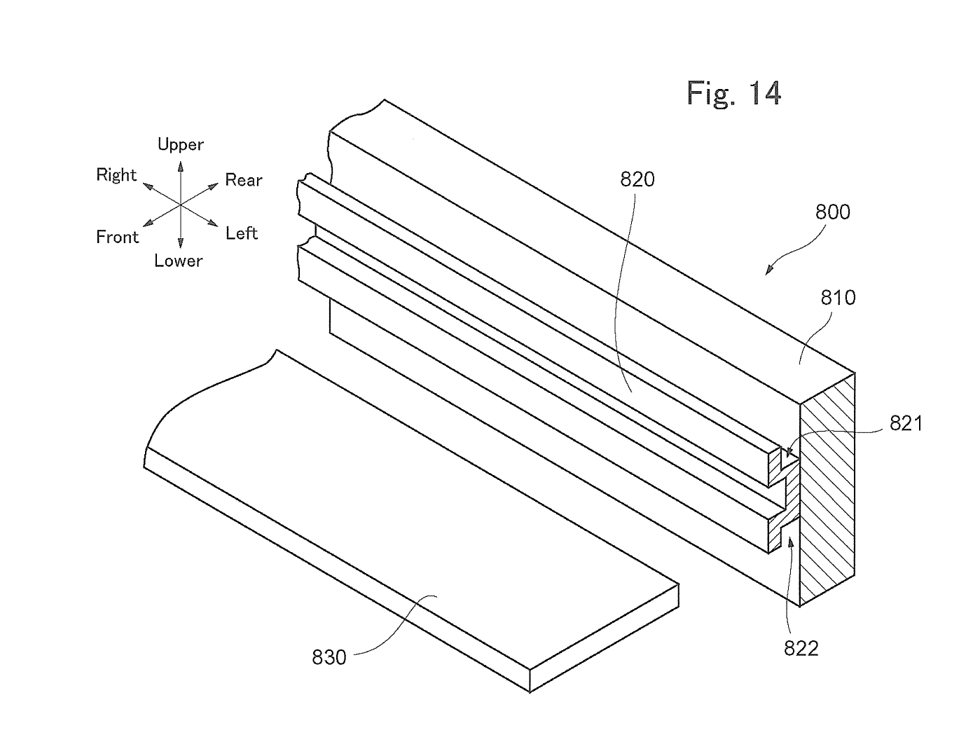

### DESCRIPTION OF EMBODIMENTS

Embodiments of the present invention will be described below based on first through third embodiments with reference to the accompanying drawings. In the following description, directions in the drawings indicated by the arrows are respectively defined as right and left, front and rear, and upper and lower for convenience of description.

### First Embodiment

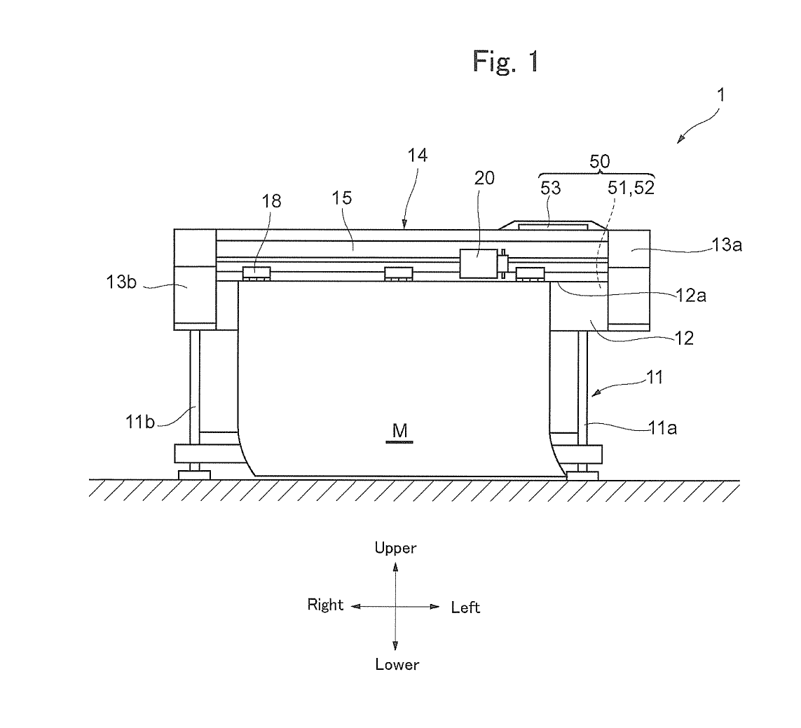

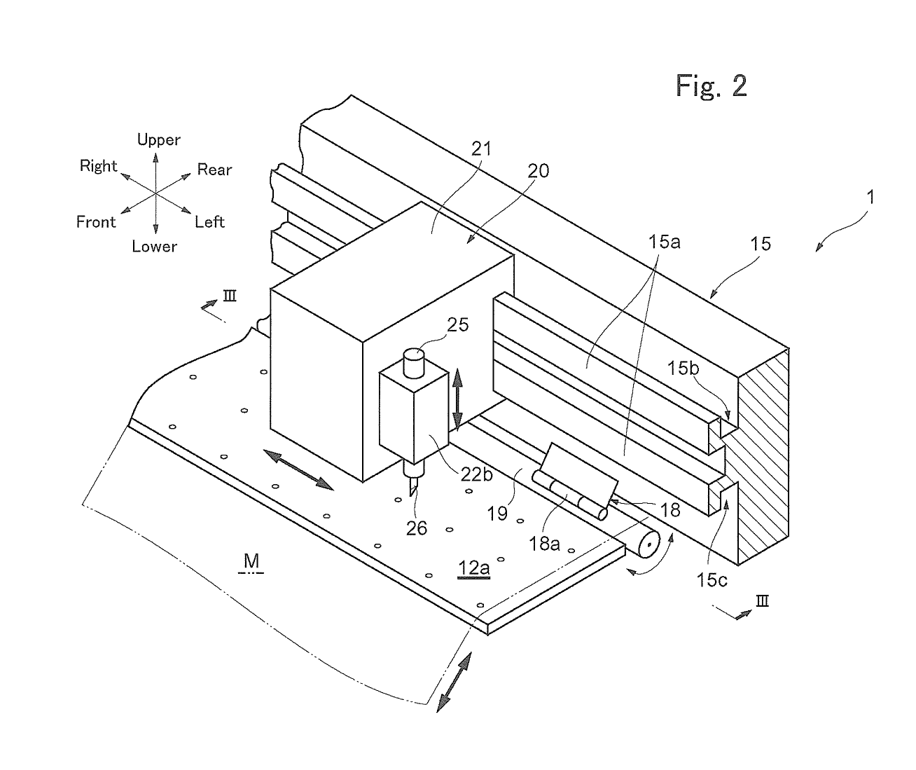

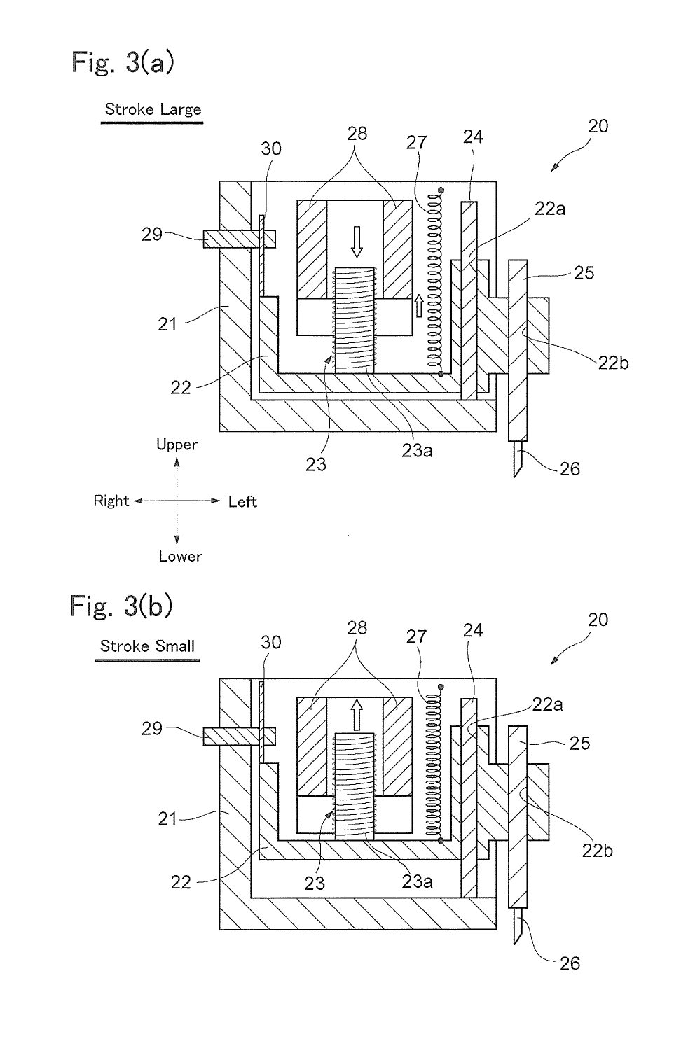

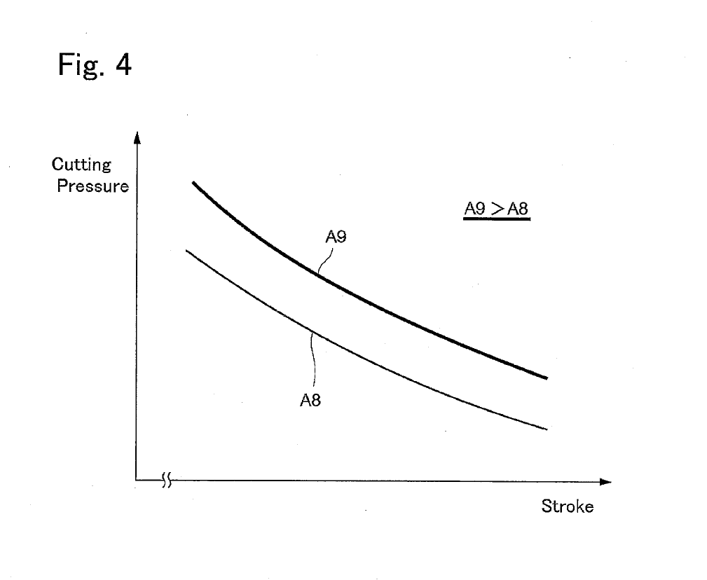

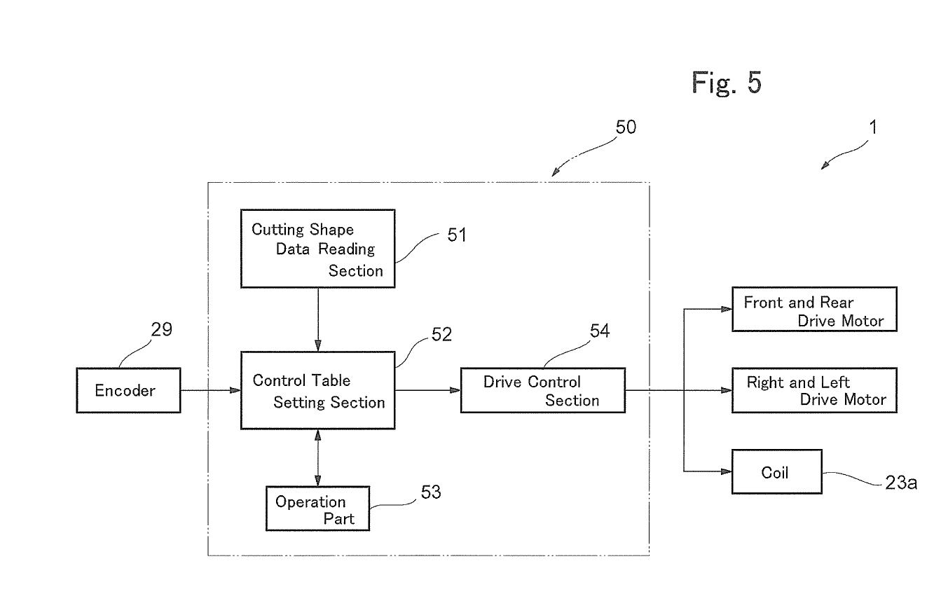

A structure of a cutting plotter 1 in accordance with a first embodiment to which the present invention is applied will be described below with reference to FIGS. 1 through 5. FIG. 1 is a view showing a cutting plotter 1 which is viewed from a front side. FIG. 2 is a perspective view showing a cutting unit 20 described below and its periphery. FIGS. 3(a) and 3(b) are cross-sectional views showing a “III-III” portion in FIG. 2. FIG. 4 is a graph showing a relationship between a stroke of a support part 22 described below (vertical position of the support part 22 with respect to a carriage 21) and a cutting pressure. FIG. 5 is a systematic control diagram for the cutting plotter 1.

In the following description, a structure is shown as an example in which a desired cutting work is performed on a sheet material “M” in a sheet shape which is an object to be performed with a cutting work by means of executing control for feeding the sheet material “M” in a front and rear direction, control for moving a cutting unit 20 described below in a right and left direction, and control for moving a cutter blade 26 described below in an upper and lower direction.

The cutting plotter 1 is, as shown in FIG. 1, structured so as to be provided with a support leg 11 having right and left support legs 11a and 11b, a center body part 12 supported by the support leg 11, a left body part 13a which is provided on a left side of the center body part 12, a right body part 13b which is provided on a right side of the center body part 12, and an upper body part 14 which is extended on an upper side of the center body part 12 so as to be in parallel to and separated from the center body part 12 and so as to connect the right and left body parts 13a and 13b with each other. The center body part 12 is provided with a flat plate-shaped platen 12a so as to be exposed on its upper face and extended in the right and left direction.

A guide member 15 which is extended in the right and left direction is disposed in an inside of the upper body part 14 (see FIG. 2). A plurality of clamp devices 18 is arranged at a lower part of the guide member 15 in the right and left direction. A pinch roller 18a is rotationally attached to a tip end part on the front side of the clamp device 18. A feed roller 19 in a cylindrical tube shape is disposed on an under side of the pinch roller 15c so as to extend in the right and left direction and exposed from the platen 12a. The feed roller 19 is rotationally driven by a front and rear drive motor (not shown) which is, for example, incorporated into the center body part 12.

The clamp device 18 is capable of being set at a clamp position where the pinch roller 18a is pressed on the feed roller 19 and an unclamp position where the pinch roller 18a is separated from the feed roller 19. According to this structure, in a state that a sheet material “M” is sandwiched between the pinch roller 18a and the feed roller 19 and the clamp device 18 is set at the clamp position, when the front and rear drive motor is driven to rotate the feed roller 19, the printing sheet “M” is fed to the front side or the rear side by a predetermined distance.

As shown in FIG. 2, the guide member 15 is arranged so as to extend in the right and left direction. In the cutting plotter 1, a width in the right and left direction of the guide member 15 is set to be about 1.6 m so as to be capable of performing a cutting work on a sheet material “M” whose width in the right and left direction is about 1.5 m. The guide member 15 is, for example, integrally formed with a guide rail 15a on its front face side which is extended in the right and left direction by means of extruding or drawing aluminum material. Further, guide grooves 15b and 15c are formed on the front face side of the guide member 15 so as to extend in the right and left direction. A carriage 21 described below is attached so as to be engaged with the guide grooves 15b and 15c and the cutting unit 20 is movable along the guide rail 15a (guide grooves 15b and 15c) in the right and left direction. The cutting unit 20 is moved in the right and left direction by a right and left drive motor (not shown) which is, for example, mounted in the inside of the right body part 13b.

The cutting unit 20 is, as shown in FIG. 3(a), mainly structured of the carriage 21, a support base 22 which is movably mounted on the carriage 21 in the upper and lower direction, and a return spring 27 which is connected with the carriage 21 and the support base 22. FIG. 3(a) shows a state where the support base 22 has been moved to the lower side and FIG. 3(b) shows a state where the support base 22 has been moved to the upper side.

The carriage 21 is provided with a permanent magnet 28, which is formed in a cylindrical tube shape whose center part is hollow, in a state that its center axis is directed in the upper and lower direction. An encoder 29 is attached to the right side of the carriage 21 so as to interpose a slit plate 30 which is mounted on the support base 22 and extended in the upper and lower direction. The encoder 29 is provided with a light emitting part and a light receiving part which are not shown and the slit plate 30 is interposed between the light emitting part and the light receiving part. Therefore, when the support base 22 is moved in the upper and lower direction, an inspection light emitted from the light emitting part is detected by the light receiving part while its intensity is alternately varied as stronger and weaker. A vertical position of the support base 22 with respect to the carriage 21 is detected on the basis of the intensity variation of the inspection light which is detected as described above.

A guide bar 24 is stood upward from a bottom part of the carriage 21 and the guide bar 24 is inserted into a guide hole 22a which is formed in the support base 22. Therefore, when the support base 22 is moved in the upper and lower direction, the support base 22 is guided by the guide bar 24 to be straightly moved in the upper and lower direction.

The support base 22 is attached with an electromagnet 23 in a cylindrical shape at a position oppositely disposed to the hollow portion of the permanent magnet 28 in a state that the center axis of the electromagnet 23 is directed in the upper and lower direction. The electromagnet 23 is structured so that a coil 23a is wound around an outer peripheral part of a core member (not shown) formed of magnetic material. According to this structure, when an electric current is supplied to the coil 23a to generate a magnetic force temporarily, the support base 22 can be moved in the upper and lower direction with respect to the carriage 21 by utilizing a repelling force or an attracting force between the electromagnet 23 and the permanent magnet 28. Further, a moving direction of the support base 22 in the upper and lower direction and a magnitude of a force acting on the support base 22 can be controlled by controlling a direction and a magnitude of an electric current which is supplied to the coil 23a. A left part of the support base 22 is formed with a holding hole 22b which is penetrated in the upper and lower direction and a holding member 25 whose lower end part is detachably mounted with a cutter blade 26 which is inserted and held by the holding hole 22b.

A length and a mounting position of the return spring 27 are previously adjusted so that, when the support base 22 is moved downward with respect to the carriage 21, an upward urging force is acted on the support base 22. FIG. 3(a) shows a balanced state where a magnetic force of the electromagnet 23 and a magnetic force of the permanent magnet 28 are repelled to each other to move the support base 22 to the lower side but an upward urging force is acted on the support base 22 by the return spring 27. On the other hand, FIG. 3(b) shows a state where an electric current is supplied to the coil 23a in an opposite direction to the case in FIG. 3(a) so that a magnetic force of the electromagnet 23 and a magnetic force of the permanent magnet 28 are attracted with each other and the support base 22 has been moved upward. When an electric current is not supplied to the coil 23a, a magnetic force is not generated in the electromagnet 23. Therefore, a vertical position of the support base 22 with respect to the carriage 21 is set at an upper position with respect to the position in FIG. 3(b) (for example, position where a bottom part of the support base 22 and a lower end part of the permanent magnet 28 are abutted with each other.

FIG. 4 shows a relationship between a stroke and a cutting pressure (force of the cutter blade 26 pressing against a sheet material “M”) in a case that an electric current is supplied to the coil 23a in a direction so that the support base 22 is moved to the lower side with respect to the carriage 21 in the cutting unit 20 which is structured as described above. Two lines in FIG. 4 respectively show a case that an electric current of a current value “A8” is supplied to the coil 23a and a case that an electric current of a current value “A9” (>A8) is supplied to the coil 23a. As shown in FIG. 4, a larger magnetic force is generated in the electromagnet 23 by supplying an electric current of a larger current value and a larger cutting pressure can be applied. Therefore, a cutting pressure can be controlled by controlling a current value supplied to the coil 23a. Further, even when an electric current of the same current value is supplied, a cutting pressure is different depending on a stroke.

As shown in FIG. 1, a control unit 50 is mounted on the left part of the cutting plotter 1. The control unit 50 is, as shown in FIG. 5, mainly structured of a cutting shape data reading section 51, a control table setting section 52, an operation part 53 and a drive control section 54. The operation part 53 is structured in an upper part of the cutting plotter 1. The cutting shape data reading section 51 and the control table setting section 52 are structured of a ROM (not shown) where data have been previously stored, a RAM (not shown) where data can be stored temporarily, or the like and mounted on a circuit board (not shown) which is incorporated into a left end portion of the center body part 12. The cutting shape data reading section 51 is a section into which shape data for a cutting work are read, and the read shape data are outputted to the control table setting section 52. The operation part 53 is a portion where an operator, for example, selects material of a sheet material “M” on which a cutting work is performed or inputs thickness of the sheet material. The set data inputted into the operation part 53 is outputted to the control table setting section 52. The control table setting section 52 is electrically connected with the encoder 29.

The control table setting section 52 is inputted with a vertical position of the support base 22 with respect to the carriage 21 which is detected by the encoder 29, shape data from the cutting shape data reading section 51, and set data from the operation part 53. The control table setting section 52 sets a control table as described below, which relates to drive control of the front and rear drive motor, drive control of the right and left drive motor, and current supply control to the coil 23a, on the basis of the respectively inputted data. The drive control section 54 performs drive control for the front and rear drive motor and the right and left drive motor and current supply control to the coil 23a on the basis of the control table which is set in the control table setting section 52.

The structure of the cutting plotter 1 has been described above. Next, an operation will be described below in which the cutter blade 26 is bitten into a sheet material “M” in the cutting plotter 1 to perform a cutting work.

First, in a state that a sheet material “M” is sandwiched between the pinch roller 18a and the feed roller 19, the clamp device 18 is set at a clamp position and a portion to be performed with a cutting work (front end portion of the sheet material “M”) is placed on the platen 12a. After that, current supply control is performed on the coil 23a so that the cutter blade 26 is pressed against and bitten into the sheet material “M”. The drive control of the front and rear drive motor and the drive control of the right and left drive motor are performed in a state that the cutter blade 26 has been bitten into the sheet material “M”. In this manner, the sheet material “M” is relatively moved with respect to the cutter blade 26 to perform a cutting work in a desired shape.

A width in the right and left direction of the guide member 15 (guide rail 15a) to which the cutting unit 20 is attached is about 1.6 m as described above. The guide member 15 is formed by extrusion molding or drawing molding but, at the time of molding, distortion of about 1 mm may occur in the current manufacturing technique. In a case that the cutting plotter 1 is structured by using the guide member 15 (guide rail 15a) having distortion of about 1 mm as described above, when the cutting unit 20 is moved along the guide rail 15a in the right and left direction, a force (cutting force pressure) by which the cutter blade 26 is pressed against the sheet material “M” is partially varied to cause a biting depth of the cutter blade 26 to be non-uniform and thus cutting quality may be affected.

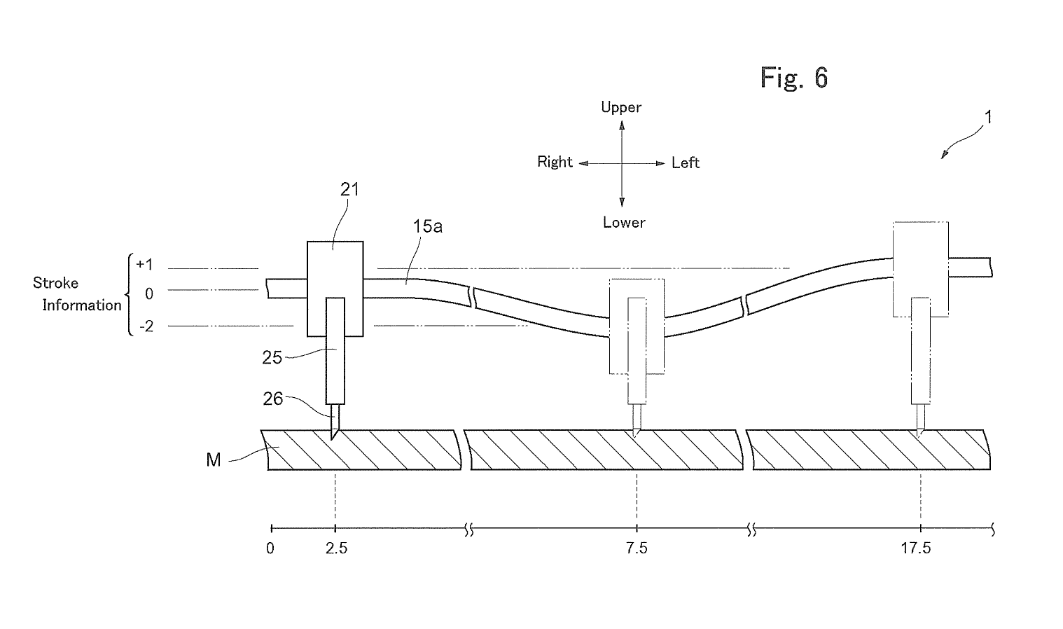

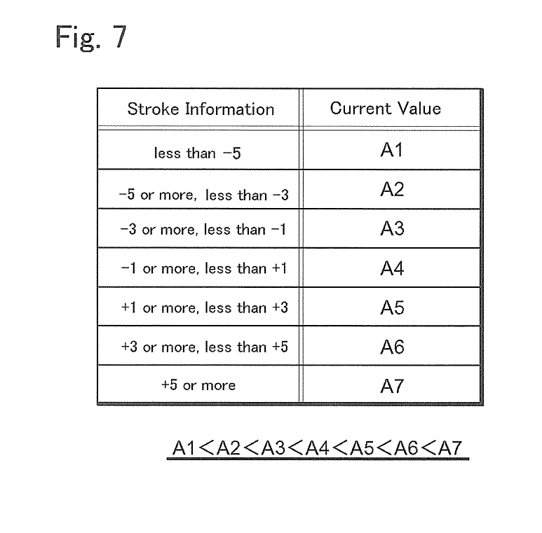

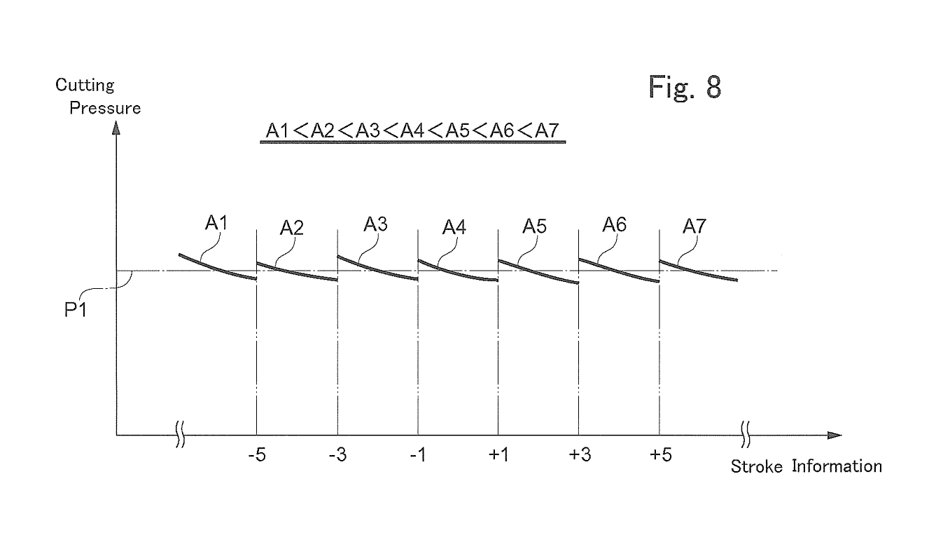

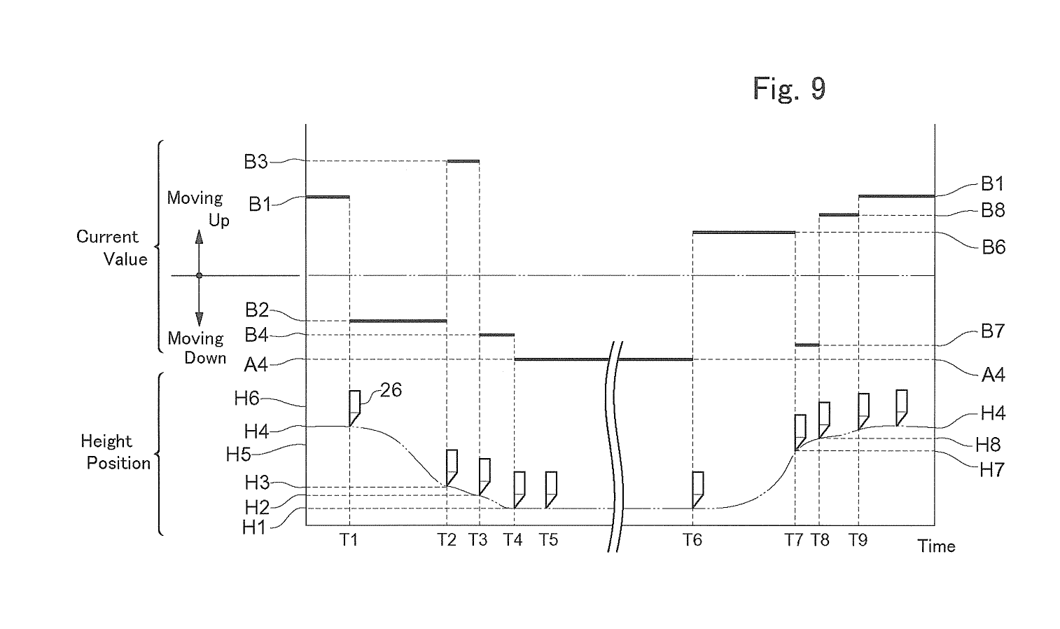

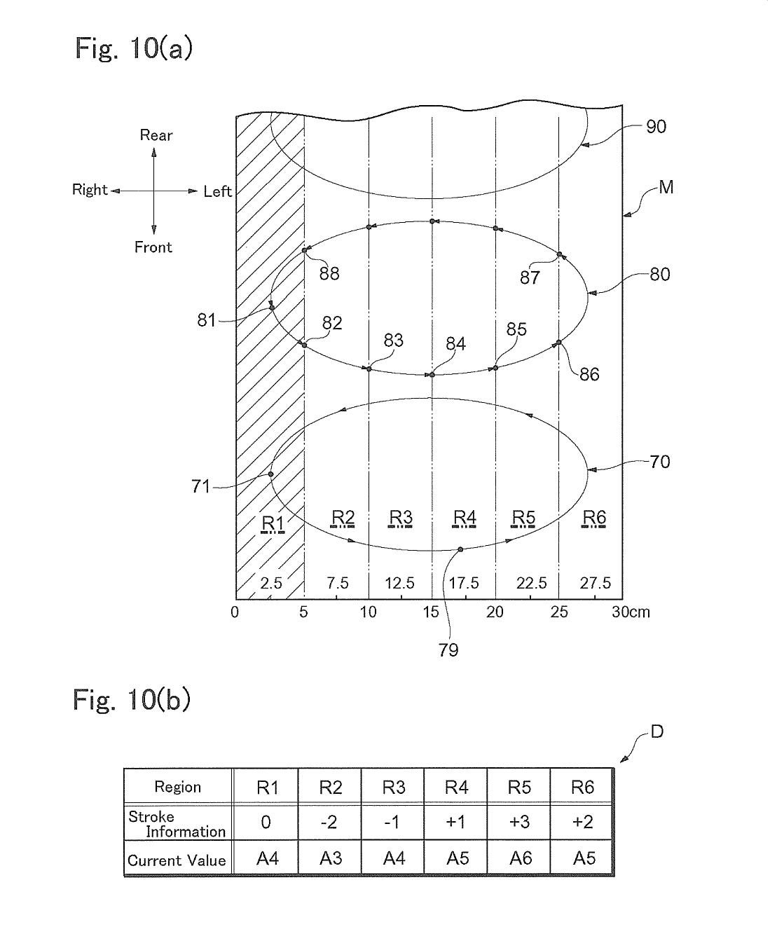

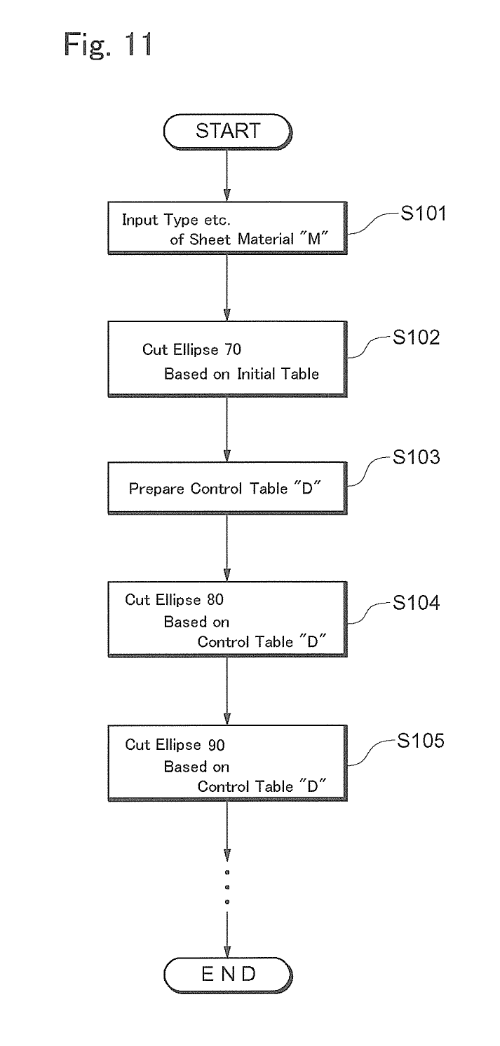

In the cutting plotter 1 to which the present invention is applied, in order to prevent lowering of cutting quality due to distortion occurred in the guide member 15, the following control is performed in the cutting work. The control will be described below on the basis of the flow chart shown in FIG. 11 with further reference to FIGS. 6 through 10(b). FIG. 6 is a schematic view showing the distorted guide rail 15a. FIG. 7 shows a relationship between stroke informations and electric current values. FIG. 8 shows a relationship between stroke informations and a cutting pressure. FIG. 9 shows control at biting and separated times. FIG. 10(a) is a plan view showing a sheet material and FIG. 10(b) shows a control table “D”.

In the following description, as an example, a case will be described in which cutting works for the same ellipse are sequentially performed on a sheet material “M” from the front side one by one as shown in FIGS. 10(a) and 10(b). In other words, an ellipse 70 shown in FIG. 10(a) is an ellipse which is firstly performed with a cutting work on the sheet material “M”, after the cutting work for the ellipse 70 has finished, an ellipse 80 is performed with a cutting work so as to be adjacent to the ellipse 70 on the rear side and then, an ellipse 90 is performed with a cutting work so as to be adjacent to the ellipse 80 on the rear side.

First, in the step S101 shown in FIG. 11, a type, thickness and the like of a sheet material “M” are inputted by an operator who operates the operation part 53 and the set data inputted as described above are outputted to the control table setting section 52. Further, the shape data of the ellipses 70, 80 and 90 . . . are outputted from the cutting shape data reading section 51 to the control table setting section 52. The control table setting section 52 sets an initial table for performing a cutting work of the ellipse 70 on the basis of the data inputted as described above. The drive control of the front and rear drive motor and the right and left drive motor and the current supply control to the coil 23a are set in the initial table. Further, the initial table is set so as to perform a desired cutting work, for example, without considering distortion of the guide member 15 (guide rail 15a) and on the assumption that the guide member 15 (guide rail 15a) and the platen 12a are located in a parallel manner.

Next, in the step S102, the data of the initial table which is set in the step S101 are outputted to the drive control section 54. The drive control section 54 drives the front and rear drive motor and the right and left drive motor and controls current supply to the coil 23a according to the initial table to perform a cutting work for the ellipse 70 (see FIG. 10(a)). In this case, the cutter blade 26 is, for example, located above a biting position 71 and then the support base 22 is moved downward so that the cutter blade 26 is bitten into the biting position 71. In the biting state as described above, the sheet material “M” is relatively moved in a counterclockwise direction with respect to the cutter blade 26 and the cutter blade 26 is returned to the biting position 71. Next, the support base 22 is moved upward at the biting position 71 to separate the cutter blade 26 from the sheet material “M” and the cutting work for the ellipse 70 is completed.

When the cutting work for the ellipse 70 is to be performed as described above, the cutting work is performed by means of relatively moving the sheet material “M” in a slow manner with respect to the cutter blade 26 while controlling supply of an electric current to the coil 23a so that a biting depth of the cutter blade 26 to the sheet material “M” is constant. While slowly performing the cutting work as described above, vertical positions of the support base 22 with respect to the carriage 21, which are detected by the encoder 29 at positions, for example, of every 5 cm in the right and left direction, are outputted to the control table setting section 52 to be stored as stroke informations.

FIG. 6 shows a relationship between right and left positions and stroke informations. In FIG. 6, when a distance from the guide rail 15a to the sheet material “M” is a reference distance (no distorted state in the guide rail 15a), the state is expressed as “zero” and a direction which becomes narrower with respect to the reference distance is defined as a “−” (minus) direction and a direction becoming larger is defined as a “+” (plus) direction. Under this definition, it is assumed that stroke informations of “0”, “−2”, “−1”, “+1”, . . . are obtained, for example, at positions of every 5 cm, i.e., 2.5 cm, 7.5 cm, 12.5 cm, 17.5 cm, . . . from the right end part shown as “0” as shown in FIG. 6 and FIG. 10(b).

Next, the step S103 is executed and, in the control table setting section 52, for example, a region of 5 cm in the right and left direction is set with the above-mentioned detecting position as a center (region “R1” with the position of 2.5 cm as a center, region “R2” with the position of 7.5 cm as a center, region “R3” with the position of 12.5 cm as a center, . . . ). In addition, current values are set in respective regions so as to obtain a desired biting depth when a cutting work is performed in each of the respective regions. The current value is, as shown in FIG. 7, set on the basis of the stroke information. Further, FIG. 8 is a graph in which a cutting pressure is further shown with a relationship between the stroke information and the current value shown in FIG. 7. As shown in FIG. 8, a desired cutting pressure “P1” which provides a desired biting depth is maintained by controlling a current value depending on the stroke information. For example, in the region “R2”, the stroke information is “−2” and thus a current value “A3” is set with reference to FIG. 7.

Therefore, in a case that a cutting work is to be performed in the region “R2”, a supply current value to the coil 23a is controlled to “A3” and thus, even when this portion of the guide rail 15a (portion of 7.5 cm from the right end) is distorted downward, a cutting work with a desired biting depth can be performed.

The current values set in the respective regions as described above are a portion relating to the current supply control to the coil 23a in the control table “D” (see FIG. 10(b)) and the drive control of the front and rear drive motor and the right and left drive motor are added to structure the control table “D”. Also as shown in FIG. 4, as the stroke becomes larger (as the permanent magnet 28 is separated further from the electromagnet 23 in the upper and lower direction), an electric current having a larger current value is required to supply to secure the desired cutting pressure “P1” and thus a magnitude relation of the current values shown in FIGS. 7 and 8 is set to be “A1<A2<A3<A4<A5<A6<A7”.

Next, the step S104 is executed in which a cutting work for the ellipse 80 is performed on the basis of the control table “D” which is prepared in the step S103. First, the cutter blade 26 is located above a biting position 81 shown in FIG. 10(a) and, in this state, the support base 22 is moved downward to make the cutter blade 26 bite. In this case, for example, when the support base 22 is moved downward at a stroke to make the cutter blade 26 bite at the biting position 81, the moving time is shortened but the cutter blade 26 may be damaged. Therefore, in the cutting plotter 1 to which the present invention is applied, control is performed in which the distortion (stroke information) of the guide rail 15a which is detected in the step S102 is reflected, the damage of the cutter blade 26 is prevented, and moving time is shortened. The control in which the cutter blade 26 is bitten into a sheet material “M” will be described below with reference to FIG. 9.

When the cutting work for the ellipse 70 has been completed and the cutter blade 26 is separated from the sheet material “M”, the current value is, for example, controlled to a value “B1” so that the electromagnet 23 is attracted to the permanent magnet 28 and held at an upper position. Next, when a cutting work for the ellipse 80 is to be started, the cutter blade 26 is located above the biting position 81 in a state of the current value “B1” and then, the current value is controlled to a value “B2” and the support base 22 (cutter blade 26) is moved downward (time period “T1” through “T2”). In this manner, the cutter blade 26 is moved downward at a stroke from a height position (distance from the sheet material “M”) “H4” to the height position “H3”. When it is detected by the encoder 29 that the cutter blade 26 has been moved downward to the height position “H3”, the current value is controlled to a value “B3” so as to move the support base 22 upward to decelerate the downward moving speed of the cutter blade 26 (time period “T2” through “T3”). When it is detected by the encoder 29 that a height variation of the support base 22 is approximately zero (height variation of the support base 22 is not more than a certain value in a constant time period) (height position “H2”), the current value is controlled to a current value “B4” to move downward to locate at the height position “H1” that is the target position (time period “T3” through “T4”).

After that, the current value is controlled to a current value “A4” so as to apply a larger cutting pressure than the current value “B4” and the cutter blade 26 is bitten into a desired biting depth (time period “T4” through “T5”). In this manner, the current value is controlled to the current value “A4” to apply a larger cutting pressure and thus a vertical vibration of the support base 22 (cutter blade 26) occurred by the return spring 27 is stabilized in a short time. As described above, after moving downward at a stroke to the vicinity of the target height position “H1”, the cutter blade 26 is slowly located at the height position “H1” and, therefore, the cutter blade 26 can be bitten in a short time without being damaged.

In the example described above, the stroke information of the biting position 81 is “0” (zero). In a case that the stroke information of the biting position 81 is, for example, “−2”, (when the cutter blade 26 is located at the height position “H5” (see FIG. 9) before starting biting), the time period “T1” through “T2” controlled to the current value “B2” is set to be shortened. Further, in a case that the stroke information of the biting position 81 is, for example, “+2”, (when the cutter blade 26 is located at the height position “H6” (see FIG. 9) before starting biting), the time period “T1” through “T2” controlled to the current value “B2” is set to be longer. According to this control as described above, the cutter blade 26 can be bitten into a sheet material “M” in a short time without damaging the cutter blade 26 depending on the stroke information of the biting position 81 (distortion of the guide rail 15a).

After the cutter blade 26 has been bitten into the sheet material “M” as described above, a cutting work for the ellipse 80 is performed in a counterclockwise direction as shown in FIG. 10(a). In this case, a portion from the biting position 81 to a boundary point 82 is included in the region “R1” (stroke information “0” (zero)) and thus the current value is controlled to the current value “A4” based on the control table “D” to perform a cutting work. As a result, a cutting work is performed with a desired biting depth from the biting position 81 to the boundary point 82. A next portion from the boundary point 82 to the boundary point 83 is included in the region “R2” (stroke information “−2”) and thus the current value is controlled to a current value “A3” based on the control table “D” to perform a cutting work. In this manner, even when the guide rail 15a is distorted toward the lower side (convex in the downward direction), a cutting work can be performed while the biting depth is maintained to be uniform regardless of the distorted amount.

Similarly, in a portion from the boundary point 83 to the boundary point 84, the value of the electric current is controlled to the current value “A4”, in a portion from the boundary point 84 to the boundary point 85, it is controlled to the current value “A5”, in a portion from the boundary point 85 to the boundary point 86, it is controlled to the current value “A6” and, in a portion from the boundary point 86 to the boundary point 87, it is controlled to the current value “A5”. In this manner, a cutting work for the ellipse 80 is continuously performed while the current value is controlled depending on the respective regions on which the cutting work is performed. When the cutting work is performed as described above, regardless of the distorted direction and the distorted amount occurred in the guide rail 15a, the cutting work for the ellipse 80 can be performed while a desired biting depth is maintained. Further, when the cutting work for the ellipse 80 is to be performed, all control informations are obtained by referring to the control table “D” and thus, a cutting work can be performed at a relatively high speed while the sheet material “M” is relatively moved to the cutter blade 26.

After a cutting work has been performed from the boundary point 88 to the biting position 81, the cutter blade 26 is moved upward in a state that the cutter blade 26 is located at the biting position 81. In this case, as shown in FIG. 9, the value of the electric current is controlled to a current value “B6” which makes the cutter blade 26 move upward and the cutter blade 26 in a biting state into the sheet material “M” is moved upward at a stroke from the height position “H1” to the height position “H7” (time period “T6” through “T7”). When it is detected by the encoder 29 that the cutter blade 26 has been moved upward to the height position “H7”, the value of the electric current is controlled to a current value “B7” for moving the support base 22 downward and the upward moving speed of the cutter blade 26 is decelerated (time period “T7” through “T8”).

When it is detected by the encoder 29 that a height variation of the support base 22 becomes approximately zero (0) (height variation of the support base 22 in a predetermined time period becomes not more than a certain value) (height position “H8”), the electric current is controlled to a current value “B8” to move upward and the cutter blade 26 is located at a target height position “H4” (time period “T8” through “T9”). After that, the electric current is controlled to a current value “B1” so as to apply a larger upward force than the current value “B8”, the cutter blade 26 is held at the upward position (after time point “T9”). As described above, after having been moved upward at a stroke to the vicinity of the target height position “H4”, the cutter blade 26 is slowly located to the height position “H4” and thus the cutter blade 26 can be moved to the upward position in a short time.

In this example, similarly to the biting operation of the cutter blade 26, the time period “T6” through “T7” is set depending on the stroke information of the biting position 81. For example, when the stroke information of the biting position 81 is “−2”, the time period “T6” through “T7” controlled to the current value “B6” is set to be shortened. On the other hand, when the stroke information of the biting position 81 is, for example, “+2”, the time period “T6” through “T7” controlled to the current value “B6” is set to be longer.

Next, the step S105 is executed. In other words, after the sheet material “M” is fed forward by a predetermined distance, a cutting work for an ellipse 90 is performed on the rear side of the ellipse 80. Also in this case, a cutting work is continuously performed while controlling the current value according to the regions “R1” through “R6” on the basis of the control table “D”. In this manner, when the ellipses 70, 80, 90 . . . have been sequentially performed with a cutting work from the front end of the sheet material “M”, the cutting work to the sheet material “M” is completed and the flow is finished.

Conventionally, the guide member and the guide rail are separately prepared and the guide rail is attached to the guide member while being adjusted and, in this manner, lowering of cutting quality due to distortion which is occurred in the guide member is prevented. On the other hand, in the cutting plotter 1 to which the present invention is applied, the guide member 15 and the guide rail 15a are integrally formed with each other by extrusion molding or drawing molding. Therefore, a manufacturing cost can be reduced largely in comparison with the conventional case. Further, since a mounting work is not required in which the guide rail is attached to the guide member while being adjusted, work man-hours are reduced and assembling work can be simplified.

In addition, the cutting plotter 1 to which the present invention is applied is structured so that a current value is controlled according to distortion of the guide member 15 (guide rail 15a) on the basis of the stroke information detected by the encoder 29. Therefore, regardless of the distortion of the guide member 15, control is automatically executed so as to obtain a desired cutting depth and thus, while distortion of the guide member 15 is permitted to some extent, quality for cutting work can be secured.

### Second Embodiment

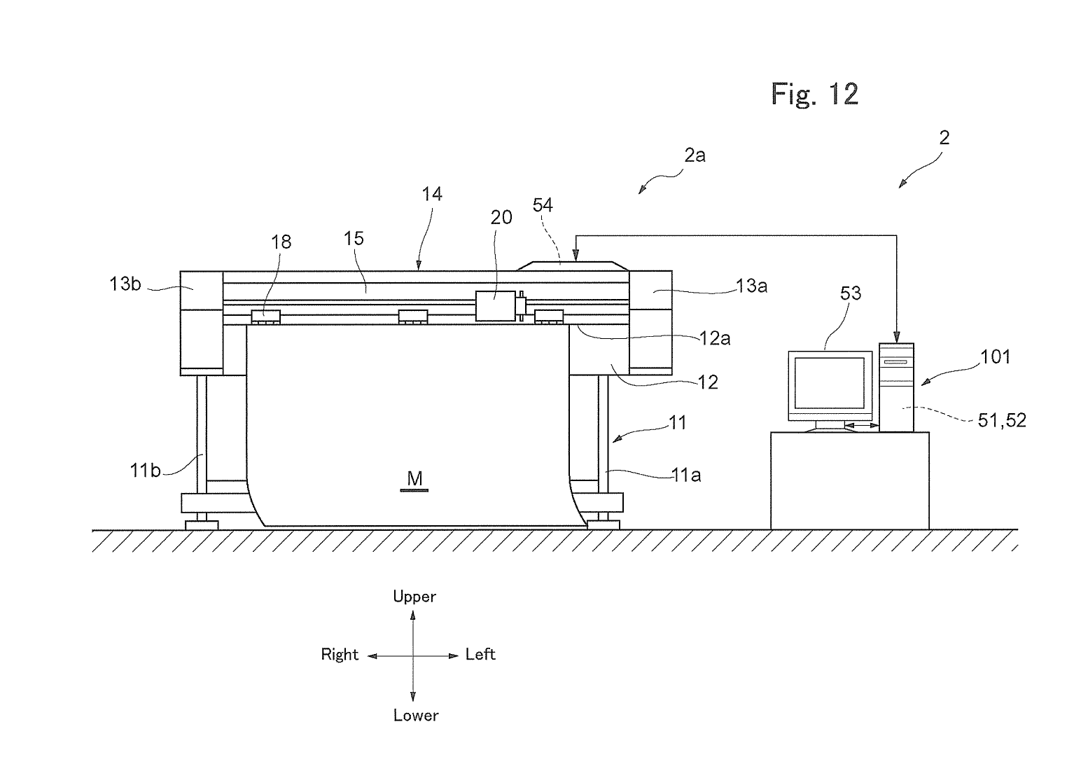

A cutting plotter 2 in accordance with a second embodiment will be described below with reference to FIG. 12. The same reference numbers are used in the same members as the cutting plotter 1 in accordance with the first embodiment and their descriptions are omitted and different portions of the structure from the cutting plotter 1 will be mainly described below.

The cutting plotter 2 is mainly structured of a plotter main body 2a, an operation part 53 comprised of a display, and a host computer 101. The host computer 101 is incorporated with a cutting shape data reading section 51 and a control table setting section 52. The plotter main body 2a is structured the same as the cutting plotter 1 except that the plotter main body 2a is not provided with the cutting shape data reading section 51, the control table setting section 52 and the operation part 53. A drive control section 54 and an encoder 29 which are mounted on the plotter main body 2a are electrically connected with the control table setting section 52 of the host computer 101.

An operation of the cutting plotter 2 will be described below as an example in which a cutting work for ellipses shown in FIG. 10(a) is performed.

First, a sheet material “M” to be performed with a cutting work is set in the plotter main body 2a. Next, a type and thickness of the sheet material “M” are inputted through the operation part 53. The control table setting section 52 is inputted with set data relating to the type and thickness of the sheet material “M” from the operation part 53 and shape data from the cutting shape data reading section 51. As a result, an initial table for performing a cutting work for an ellipse 70 is set in the control table setting section 52. Next, a cutting work for the ellipse 70 is performed on the front end part on the basis of the initial table. In this case, similarly to the first embodiment, vertical positions of the support base 22 with respect to the carriage 21 which are detected by the encoder 29 are outputted to the control table setting section 52 and stored as stroke informations. The control table setting section 52 prepares a control table “D” on the basis of the stroke informations. Then, similarly to the first embodiment, cutting works for the ellipses 80, 90, . . . are performed with reference to the control table “D”.

As described above, the cutting shape data reading section 51 and the control table setting section 52 are incorporated into the host computer 101 and an operator can handle while watching the operation part 53, i.e., a display. Therefore, for example, updating, addition and the like of the shape data which are stored in the cutting shape data reading section 51 can be simply performed.

### Third Embodiment

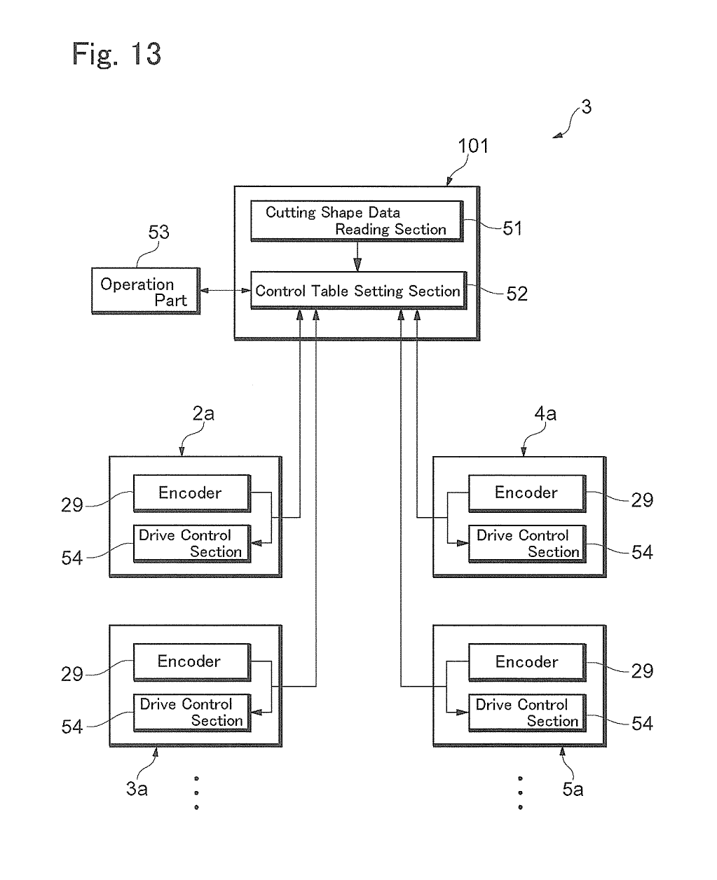

A cutting plotter 3 in accordance with a third embodiment will be described below with reference to FIG. 13. The same reference numbers are used in the same members as the cutting plotter 2 in accordance with the second embodiment and their descriptions are omitted and different portions of the structure from the cutting plotter 2 will be mainly described below.

The cutting plotter 3 in accordance with the third embodiment is mainly structured of an operation part 53 comprised of a display, a host computer 101, and a plurality of plotter main bodies 2a, 3a, 4a, 5a, . . . Each of the plotter main bodies 3a, 4a, 5a, . . . is provided with the same structure as the above-mentioned plotter main body 2a. A drive control section 54 and an encoder 29 which are mounted on each of the plotter main bodies are electrically connected with a control table setting section 52 of the host computer 101. According to this structure, each of the plurality of the plotter main bodies 2a, 3a, 4a, 5a, . . . can be driven and controlled by one host computer 101. Therefore, the structure is especially effective in a case that a plurality of the plotter main bodies 2a, 3a, 4a, 5a, . . . are simultaneously operated.

In the embodiments described above, a structure for performing cutting works for the ellipses 70, 80, 90, . . . having the same shape so as to be adjacent to each other in the front and rear direction is shown as an example but the present invention is not limited to this structure. The present invention may be applied to a case that, for example, cutting works for various kinds of shape other than an ellipse are performed or a plurality of cutting works is performed in the right and left direction.

In the embodiments described above, when the cutting works for a second and subsequent ellipses 80, 90, . . . are to be performed, the cutting work is performed on the basis of the stroke informations obtained in the first cutting work. However, the present invention is not limited to this structure. For example, it is structured that, at the time of performing cutting works for a second and subsequent ellipses 80, 90, . . . , a current value is controlled so that a desired cutting pressure “P1” is maintained and the current value is detected. When the current value detected as described above exceeds a preset threshold value, the control table (current value) of the region where the threshold value is exceeded is amended. Then, when a cutting work for the next ellipse is to be performed, a cutting work is performed on the basis of the amended control table with respect to the ellipse which exceed the threshold value at the time of the above-mentioned cutting work. According to this structure, a cutting work for the ellipse can be performed while maintaining a desired biting depth in a further high degree of accuracy.

Further, in the embodiments described above, control for feeding a sheet material “M” in the front and rear direction and control for moving the cutter blade 26 along the guide rail 15a in the right and left direction are performed in a combined manner so that the sheet material “M” is relatively moved with respect to the cutter blade 26. However, the present invention is not limited to this structure. For example, the present invention may be applied to a type of cutting plotter in which a cutter blade is moved in the front and rear direction and the right and left direction with respect to a fixed sheet material.

In the embodiments described above, a cutting work is performed on a sheet material “M” by using the cutter blade 26 but the present invention is not limited to this structure. For example, the present invention may be applied to a cutting plotter which uses an end mill which performs a cutting work on a medium to be cut instead of using the cutter blade 26.

In the embodiment described above, when a cutting work is to be performed by means of relatively moving a sheet material “M” with respect to the cutter blade 26, it may be structured so that, for example, the cutter blade 26 is finely moved up and down to form a sheet material “M” with portions where the cutter blade 26 is penetrated and portions where the cutter blade 26 is not penetrated. When such a cutting work is performed, the ellipses 70, 80, 90, . . . are not separated from the sheet material “M” completely and thus feeding of the sheet material “M” which has been performed with the cutting work and the like is easy.

In the embodiments described above, the regions “R1” through “R6” are prepared as the stroke information at every 5 cm and a current value is set in each of the regions so as to provide a desired cutting “P1” but the present invention is not limited to this structure. For example, a method may be adopted that the stroke information is obtained continuously instead of every 5 cm and, at the time of cutting work, a current value is continuously controlled depending on the moving position of the carriage 21 in the right and left direction.

In the embodiments described above, the stroke information is obtained while performing a cutting work for the ellipse 70 according to the initial table but the present invention is not limited to this method. For example, a method may be adopted that the cutter blade 26 is pressed against a sheet material “M” with a pressure not to bite into the sheet material “M” and, in this state, the cutter blade 26 and the sheet material “M” are relatively moved to each other to obtain stroke information.

Further, the following control may be also adopted other than the control in the embodiments described above. For example, when a cutting work for the ellipse 70 is to be performed from the biting position 71 shown in FIG. 10(a), all of the ellipse 70 may be performed with a cutting work on the basis of the stroke information of the biting position 71. In this case, since the stroke information of the biting position 71 is “0” (zero), the ellipse 70 is performed with a cutting work under a state that an electric current is controlled to the current value “A4”. When a cutting work is to be performed from the biting position 79 which is included in the region “R4”, the ellipse 70 is performed with a cutting work under a state that an electric current is controlled to the current value “A5”. According to this control, the control structure can be simplified and a working time required to perform a cutting work can be shortened.

### [Reference Signs List]

“M” sheet material (medium to be cut)
1 cutting plotter
12a platen (medium support means)
15 guide member
15a guide rail (guide member)
21 carriage
23 electromagnet (solenoid)
26 cutter blade (cutting tool)
28 permanent magnet (solenoid)
50 control unit (working control means)

What is claimed is:

1. A cutting plotter comprising:
a medium support means which supports a medium to be cut that is formed in a sheet shape;
a guide member which is relatively moved in a feeding direction with respect to the medium that is supported on the medium support means in a state facing to the medium support means, and the guide member being provided so as to extend in a scanning direction perpendicular to the feeding direction;
a carriage which is attached to the guide member and is movable along the guide member in the scanning direction;
a cutting tool which is mounted on the carriage and is movable in a biting direction perpendicular to the medium that is supported on the medium support means; and
a working control means which performs control for relatively moving the guide member in the feeding direction, control for moving the carriage along the guide member, and control for moving the cutting tool in the biting direction to perform a cutting work on the medium by the cutting tool;
wherein when the control for moving the carriage in the scanning direction along the guide member is to be performed by the working control means,
in a case that a distance between the medium and the carriage in the biting direction is wider than a predetermined distance, control for moving the cutting tool in a biting direction into the medium is added, and
in a case that the distance between the medium and the carriage in the biting direction is narrower than the predetermined distance, control for moving the cutting tool in a separating direction from the medium is added.

2. The cutting plotter according to claim 1, wherein
the carriage is mounted with a solenoid for moving the cutting tool in the biting direction, and
the working control means performs control for moving the cutting tool in the biting direction by controlling a supply current to the solenoid.

3. A cutting method performed in a cutting plotter including a carriage which faces a medium support means supporting a medium to be cut that is formed in a sheet shape and which is movable along a guide member extended in a scanning direction and a cutting tool which is mounted on the carriage so as to be movable in a biting direction perpendicular to the medium that is supported on the medium support means, and a cutting work is performed while the cutting tool is relatively moved with respect to the carriage in a state that the cutting tool is bitten into the medium, the cutting method comprising:
a first step in which the cutting tool is moved in the biting direction depending on a distance between the medium and the carriage in the biting direction; and
a second step in which the cutting tool having been moved in the first step is moved in the scanning direction along the guide member.
